(19) United States
(12) Patent Application Publication
(10) Pub. No.: US 2024/0204396 A1
(43) Pub. Date: Jun. 20, 2024

(54) ANTENNA AND RADIO COMMUNICATION SYSTEM

(71) Applicant: NEC Platforms, Ltd., Kawasaki-shi, Kanagawa (JP)

(72) Inventor: Jun UCHIDA, Kanagawa (JP)

(73) Assignee: NEC Platforms, Ltd., Kawasaki-shi, Kanagawa (JP)

(21) Appl. No.: 17/766,594

(22) PCT Filed: Sep. 23, 2020
(86) PCT No.: PCT/JP2020/035712

§ 371 Date: Feb. 2, 2024

(30) Foreign Application Priority Data
Oct. 29, 2019 (JP) 2019-195862

(51) Int. Cl. H01Q 1/50; H01Q 1/12; H01Q 1/32; H01Q 9/04

(52) U.S. Cl. CPC H01Q 1/50; H01Q 1/1271; H01Q 1/325; H01Q 9/0414; H01Q 9/0421

(57) ABSTRACT

An antenna and a radio communication system that are capable of improving the design quality of the antenna at a low cost are provided. According to an example embodiment, an antenna (20) includes a parasitic antenna element (21) formed using a transparent conduction film, in which the parasitic antenna element (21) is not in contact with a feeding point (13) and is disposed near a feeding antenna element (11) of a radio communication apparatus (10) configured to function as a radio communicator, and an induction current is generated in the parasitic antenna element (21) by a driving current of the feeding antenna element.

### TECHNICAL FIELD

The present invention relates to an antenna and a radio communication system.

### BACKGROUND ART

A parasitic antenna element has a role of improving the performance of a feeding antenna element to which radio waves are fed (supplied). The improvements of the performance include improvements of the efficiency and bandwidth of an antenna, multi-polarization, and directivity.

### CITATION LIST

### Patent Literature

Patent Literature 1: Japanese Patent No. 6412059
Patent Literature 2: Japanese Unexamined Patent Application Publication No. 2005-072645
Patent Literature 3: Japanese Unexamined Patent Application Publication No. 2004-318571

### SUMMARY OF INVENTION

### Technical Problem

When a metal such as a sheet metal, a printed circuit board, or an aluminum sheet is used as a material for a parasitic antenna element which is not in contact with a feeding point, there is a problem with a design quality of the antenna since the material is metal.

Further, when a transparent conduction film is used as a feeding antenna element, it is possible to design the antenna so that the outward appearance thereof becomes simple. However, since the transparent conduction film has to be processed, there is a disadvantage that the antenna becomes expensive. The transparent conduction film is soft and brittle. Therefore, at a feeding point connecting a radio circuit to a transparent conduction antenna, processing for adding a reinforcing plate, a paste of, for example, gold or silver, and the like to an electrode contact part is required, and thus the antenna becomes very expensive.

In view of the above-described circumstances, an object of the present disclosure is to provide an antenna and a radio communication system that are capable of improving the design quality of the antenna at a low cost.

### Solution to Problem

An antenna according to an example embodiment includes a parasitic antenna element formed using a transparent conduction film, in which the parasitic antenna element is not in contact with a feeding point and is disposed near a feeding antenna element of a radio communication apparatus configured to function as a radio communicator, and an induction current is generated in the parasitic antenna element by a driving current of the feeding antenna element.

A radio communication system according to another example embodiment includes: a radio communication apparatus including a feeding antenna element, the radio communication apparatus being configured to function as a radio communicator; and an antenna including a parasitic antenna element formed using a transparent conduction film, in which the parasitic antenna element is not in contact with a feeding point and is disposed near the feeding antenna element, and an induction current is generated in the parasitic antenna element by a driving current of the feeding antenna element.

### Advantageous Effects of Invention

According to an example embodiment, it is possible to provide an antenna and a radio communication system that are capable of improving the design quality of the antenna at a low cost.

### BRIEF DESCRIPTION OF DRAWINGS

FIG. 1 is a perspective view illustrating an antenna and a radio communication system according to a comparative example 1;

FIG. 2 is a configuration diagram illustrating the antenna and the radio communication system according to the comparative example 1;

FIG. 3 is a perspective view illustrating an antenna and a radio communication system according to a first example embodiment;

FIG. 4 is a configuration diagram illustrating the antenna and the radio communication system according to the first example embodiment;

FIG. 5 is a graph illustrating antenna performances of a radio communication apparatus and the radio communication system according to the first example embodiment, and the upper part thereof shows a case in which the radio communication apparatus is a single unit and the lower part thereof shows a case in which an antenna is added to the radio communication apparatus;

FIG. 6 is a graph illustrating antenna performances of the radio communication apparatus and the radio communication system according to the first example embodiment, and the upper part thereof shows a case in which the radio communication apparatus is a single unit and the lower part thereof shows a case in which the antenna is added to the radio communication apparatus;

FIG. 7 is a graph illustrating antenna performances of the radio communication apparatus and the radio communication system according to the first example embodiment, and the upper part thereof shows a case in which the radio communication apparatus is a single unit and the lower part thereof shows a case in which the antenna is added to the radio communication apparatus;

FIG. 8 is a diagram illustrating a radio communication system according to a comparative example 2;

FIG. 9 is a configuration diagram illustrating the radio communication system according to the comparative example 2;

FIG. 10 is a configuration diagram illustrating an antenna and a radio communication system according to a second example embodiment;

FIG. 11 is a configuration diagram illustrating the antenna and the radio communication system according to the second example embodiment;

FIG. 12 is a diagram illustrating an antenna and a radio communication system according to a third example embodiment;

FIG. 13 is a diagram illustrating the antenna and the radio communication system according to the third example embodiment;

FIG. 14 is a diagram illustrating another shape of the antenna according to the third example embodiment;

FIG. 15 is a diagram illustrating another shape of the antenna according to the third example embodiment;

FIG. 16 is a diagram illustrating the number of radio waves of the radio communication system according to the third example embodiment emitted outside a vehicle;

FIG. 17 is a diagram illustrating an antenna and a radio communication system according to a fourth example embodiment; and

FIG. 18 is a diagram illustrating a state in which the antenna according to the fourth example embodiment is attached to and detached from a roof of a vehicle.

### DESCRIPTION OF EMBODIMENTS

An antenna and a radio communication system according to example embodiments will be described hereinafter with reference to the drawings. Note that reference symbols added in each of the drawings for respective components are added as examples to assist the understanding thereof for the sake of convenience, and it is needless to say that they are not added with the intention of limiting the present invention to example embodiments shown in the drawings.

### First Example Embodiment

First, an outline of an antenna according to a first example embodiment will be described. The antenna according to this example embodiment includes a parasitic antenna element using a transparent conduction film. The parasitic antenna element is not in contact with a feeding point and disposed near a feeding antenna element of a radio communication apparatus that functions as a radio communicator, and an induction current is generated in the parasitic antenna element by a driving current of the feeding antenna element. By the above structure, the intimidating effect of the antenna according to this example embodiment can be reduced and the quality of a simple-looking design of the antenna can be improved. Further, since the antenna according to this example embodiment has a non-contact structure, additional processing for connecting a transparent conduction film which it is difficult to process to the feeding point is not required. Therefore, it is possible to provide an antenna having an improved design quality at a low cost.

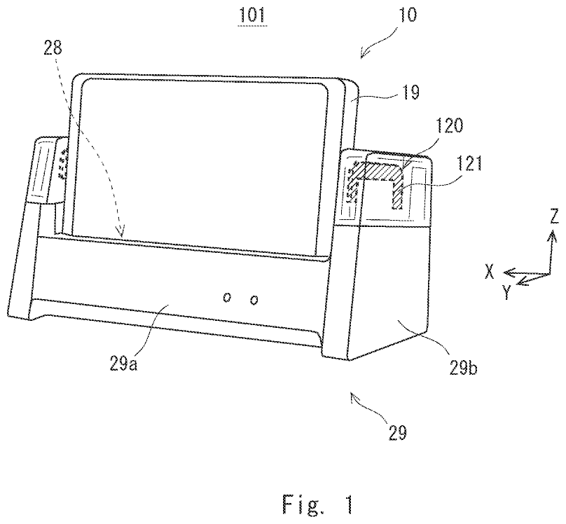

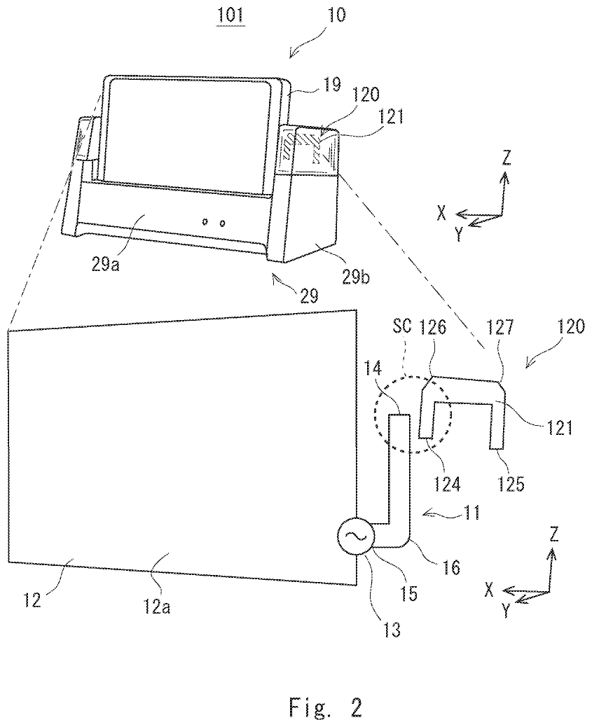

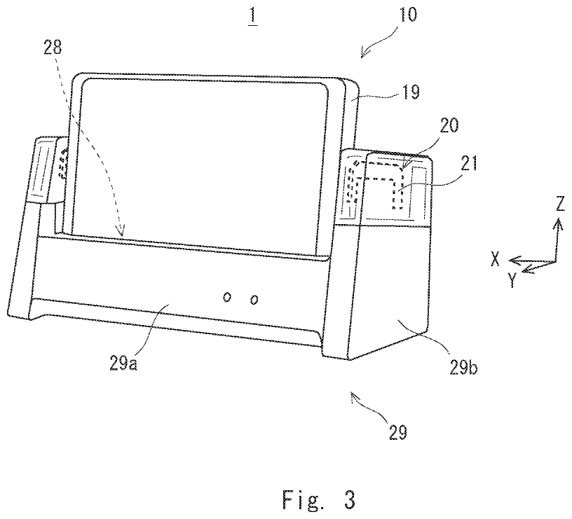

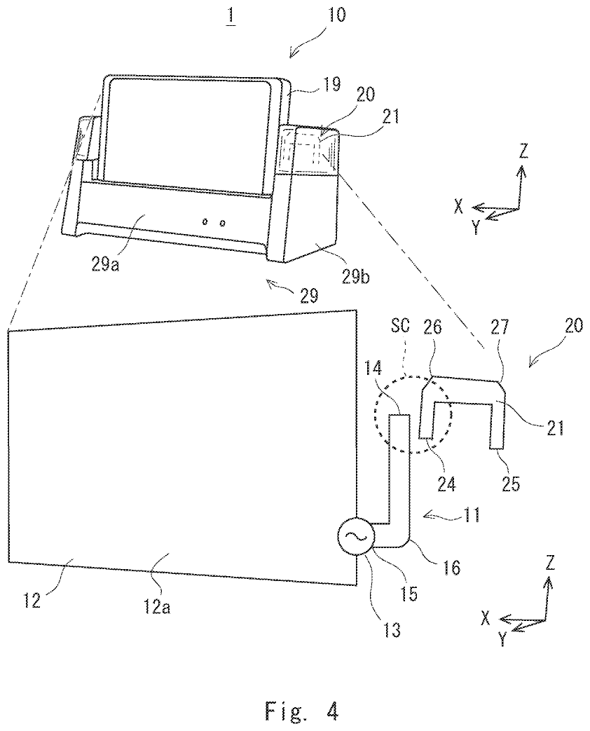

Next, the antenna and a radio communication system according to this example embodiment will be described in detail. In order to make an understanding of the antenna and the radio communication system according to this example embodiment clearer, a comparison between it and an antenna and a radio communication system according to a comparative example 1 will be described. FIG. 1 is a perspective view illustrating the antenna and the radio communication system according to the comparative example 1. FIG. 2 is a configuration diagram illustrating the antenna and the radio communication system according to the comparative example 1. FIG. 3 is a perspective view illustrating the antenna and the radio communication system according to the first example embodiment. FIG. 4 is a configuration diagram illustrating the antenna and the radio communication system according to the first example embodiment.

As shown in FIGS. 1 and 2, a radio communication system 101 according to the comparative example 1 includes a radio communication apparatus 10 and an antenna 120.

The radio communication apparatus 10 functions as a radio communicator. For example, the radio communication apparatus 10 is a mobile Wi-Fi router. Note that the radio communication apparatus 10 is not limited to a mobile Wi-Fi router if it functions as a radio communicator. The radio communication apparatus 10 includes a feeding antenna element 11, a substrate 12, and a feeding point 13 inside a rectangular parallelepiped housing 19. The substrate 12 is, for example, a printed circuit board on which components of the radio communication apparatus 10 are mounted. The feeding point 13 is disposed in the substrate 12. For example, the feeding antenna element 11 is connected to the substrate 12 via the feeding point 13. The substrate 12 includes, for example, a rectangular substrate surface 12a.

Here, an XYZ-orthogonal coordinate system is introduced for the sake of describing the radio communication system 101. A direction perpendicular to the substrate surface 12a of the substrate 12 is defined as the Y-axis direction. Two orthogonal directions parallel to the substrate surface 12a are defined as the X-axis direction and the Z-axis direction. For example, each side of the substrate 12 is extended along the X-axis and the Z-axis directions.

The feeding antenna element 11 has, for example, an inverted L-shape in which a thin metal piece having one end 14 and an other end 15 is bent at a right angle in a bending part 16. A part of the feeding antenna element 11 from the one end 14 to the bending part 16 extends in the −Z-axis direction. A part of the feeding antenna element 11 from the bending part 16 to the other end 15 extends in the +X-axis direction. For example, the length of the feeding antenna element 11 from the one end 14 to the bending part 16 is longer than the length thereof from the other end 15 to the bending part 16. Note that the shape of the feeding antenna element 11 is not limited to an inverted L-shape, and may instead be, for example, an L-shape or an F-shape. Further, the feeding antenna element 11 may be a single element, and it may be formed on a chip or the like or it may be formed on the substrate 12.

The other end 15 of the feeding antenna element 11 is connected to the feeding point 13 of the substrate 12. A driving current is supplied from the feeding point 13 to the feeding antenna element 11. The driving current is, for example, a high frequency current, and the feeding antenna element 11 emits radio waves by this current. The feeding antenna element 11 is disposed, for example, in an end part of the housing 19. Note that the configuration of the radio communication apparatus 10 according to the comparative example 1 is similar to that of the radio communication apparatus 10 according to the first example embodiment described later.

The antenna 120 is attached to an installation part 29. The installation part 29 is, for example, a charging cradle that is an accessory to a mobile Wi-Fi router. Note that the installation part 29 is not limited to a charging cradle. The installation part 29 includes a rectangular parallelepiped base 29a provided with a recessed part 28 into which the radio communication apparatus 10 is fitted from above, and a support part 29b that supports the base 29a from both sides thereof in the direction in which the recessed part 28 extends. The antenna 120 is disposed in the support part 29b of the installation part 29. For example, the antenna 120 is disposed inside the support part 29b including a transparent member. The antenna 120 is disposed near the feeding antenna element 11 of the radio communication apparatus 10.

The antenna 120 includes a parasitic antenna element 121. Therefore, the parasitic antenna element 121 is disposed in a charger of the radio communication apparatus 10. The parasitic antenna element 121 is formed using a metal film. For example, the parasitic antenna element 121 is formed using an aluminum film. The parasitic antenna element 121 has conductivity. Note that the parasitic antenna element 121 may be formed using other conductive members having conductivity other than aluminum. The parasitic antenna element 121 enhances an antenna performance of the feeding antenna element 11 in the radio communication apparatus 10.

The parasitic antenna element 121 has a bent shape. For example, the parasitic antenna element 121 has a U-shape in which a thin metal piece having one end 124 and an other end 125 is bent at a right angle in a bending part 126 and bent at a right angle at a bending part 127. A part of the parasitic antenna element 121 from the one end 124 to the bending part 126 extends in the +Z-axis direction. A part of the parasitic antenna element 121 from the bending part 126 to the bending part 127 extends in the −Y-axis direction. A part of the parasitic antenna element 121 from the bending part 127 to the other end 125 extends in the −Z-axis direction. For example, the length of the parasitic antenna element 121 from the bending part 126 to the bending part 127 is longer than the length thereof from the one end 124 to the bending part 126 and the length thereof from the bending part 127 to the other end 125. Note that the shape of the parasitic antenna element 121 is not limited to a U-shape, and may instead be, for example, a rod shape.

The parasitic antenna element 121 is not in contact with the feeding point 13 of the substrate 12, and is also not in contact with other feeding points. The parasitic antenna element 121 is spatially coupled to the feeding antenna element 11. For example, a length of the parasitic antenna element 121 from the one end 124 to the other end 125 is approximately ½ of a wavelength of a radio wave emitted by the feeding antenna element 11. Further, the parasitic antenna element 121 is located near the feeding antenna element 11 of the radio communication apparatus 10. For example, the one end 14 of the feeding antenna element 11 and the one end 124 of the parasitic antenna element 121 are spatially coupled to each other at a space coupling part SC. By the above, an induction current is generated in the parasitic antenna element 121 by the driving current of the feeding antenna element 11. The induction current generated in the parasitic antenna element 121 may have a current component in which a direction thereof is different from the direction of the driving current. The induction current generated in the parasitic antenna element 121 is a resonance current.

The above-described radio communication system 101 according to the comparative example 1 can improve the antenna performance of the radio communication apparatus 10. However, the parasitic antenna element 121 of the antenna 120 is formed using an aluminum film. Therefore, there is a problem with the design quality of the antenna since the outward appearance thereof is not simple.

Next, the radio communication system according to this example embodiment will be described. As shown in FIGS. 3 and 4, the radio communication system 1 according to the first example embodiment includes the radio communication apparatus 10 and an antenna 20. The configuration of the radio communication apparatus 10 according to the first example embodiment is similar to that of the radio communication apparatus 10 according to the comparative example. In FIGS. 3 and 4, an XYZ-orthogonal coordinate system similar to that used in FIGS. 1 and 2 is used.

Further, the structure in which the antenna 20 according to the first example embodiment is attached to the installation part 29 is similar to the structure in which the antenna 120 according to the comparative example 1 is attached to the installation part 29. That is, the antenna 20 is disposed in the support part 29b of the installation part 29, and is disposed near the feeding antenna element 11 of the radio communication apparatus 10.

The antenna 20 according to the first example embodiment includes a parasitic antenna element 21. The parasitic antenna element 21 is formed using a transparent conduction film. The transparent conduction film has conductivity. Further, the transparent conduction film is transparent, and thus one side of the transparent conduction film can be seen from the other side therethrough. As described above, the antenna 20 according to the first example embodiment uses a transparent conduction film as the non-contact parasitic antenna element 21.

Like the parasitic antenna element 121 according to the comparative example 1, the parasitic antenna element 21 has a bent shape. For example, the parasitic antenna element 21 has a U-shape in which a thin metal piece having one end 24 and an other end 25 is bent at a right angle in a bending part 26 and bent at a right angle at a bending part 27. A part of the parasitic antenna element 21 from the one end 24 to the bending part 26 extends in the +Z-axis direction. A part of the parasitic antenna element 21 from the bending part 26 to the bending part 27 extends in the −Y-axis direction. A part of the parasitic antenna element 21 from the bending part 27 to the other end 25 extends in the −Z-axis direction. For example, the length of the parasitic antenna element 21 from the bending part 26 to the bending part 27 is longer than the length thereof from the one end 24 to the bending part 26 and the length thereof from the bending part 27 to the other end 25. A length of the parasitic antenna element 21 from the one end 24 to the other end 25 is approximately ½ of a wavelength of a radio wave radiated by the feeding antenna element 11. The parasitic antenna element 21 is not in contact with the feeding point 13 of the substrate 12, and is also not in contact with other feeding points.

The parasitic antenna element 21 is spatially coupled to the feeding antenna element 11. For example, the parasitic antenna element 21 is located near the feeding antenna element 11 of the radio communication apparatus 10. Further, the one end 14 of the feeding antenna element 11 and the one end 24 of the parasitic antenna element 21 are spatially coupled to each other at the space coupling part SC. By the above, an induction current is generated in the parasitic antenna element 21 by the driving current of the feeding antenna element 11. The induction current generated in the parasitic antenna element 21 may have a current component in which a direction thereof is different from the direction of the driving current. The induction current generated in the parasitic antenna element 21 is a resonance current.

Next, an operation of a radio communication system 1 according to the first example embodiment will be described. As shown in FIG. 4, the other end 15 of the feeding antenna element 11 having an inverted L-shape is connected to the feeding point 13. The one end 14 of the feeding antenna element 11 is located at the space coupling part SC where it is coupled to the parasitic antenna element 21. At the space coupling part SC, the one end 14 of the feeding antenna element 11 and the one end 24 of the parasitic antenna element 21 are made to couple to each other with a high frequency voltage. By doing the above, a high frequency voltage is induced in the non-contact parasitic antenna element 21 which is not fed. Therefore, a high frequency current, which is a source of radio waves, flows through the parasitic antenna element 21. Further, the parasitic antenna element 21 emits an antenna, that is, a radio wave.

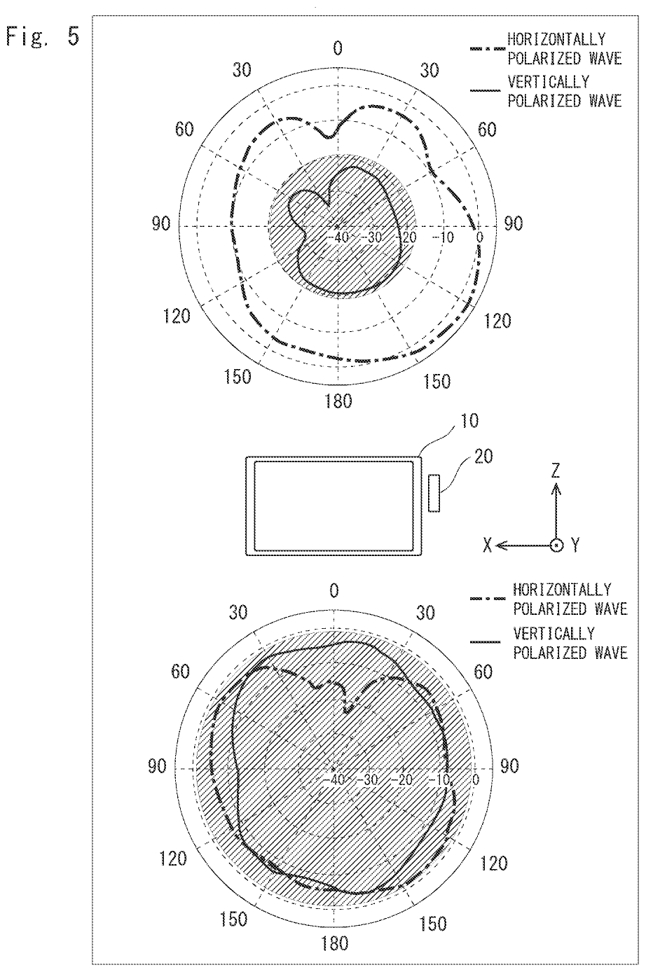

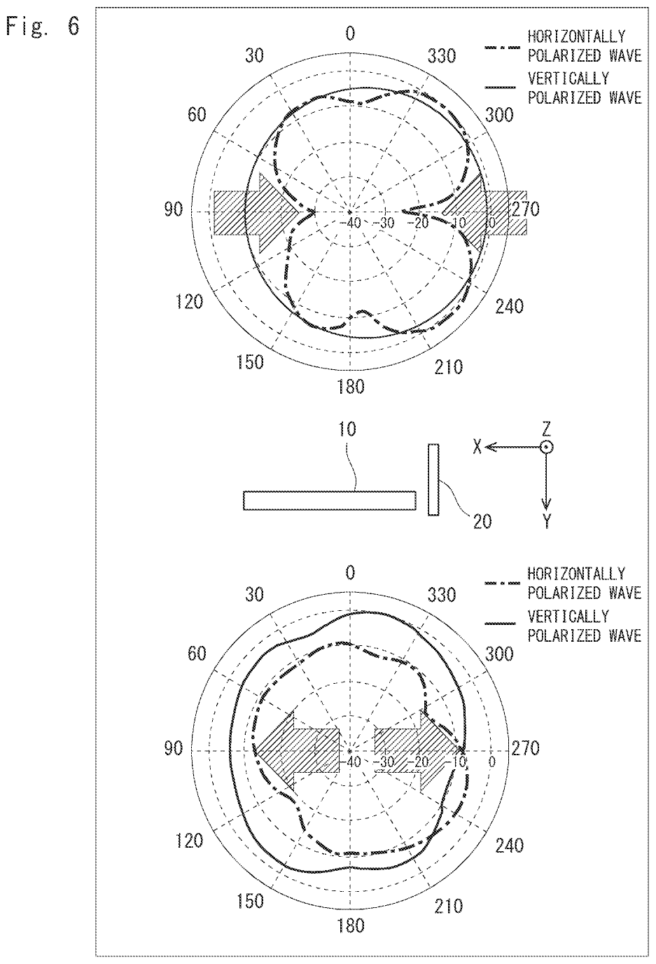

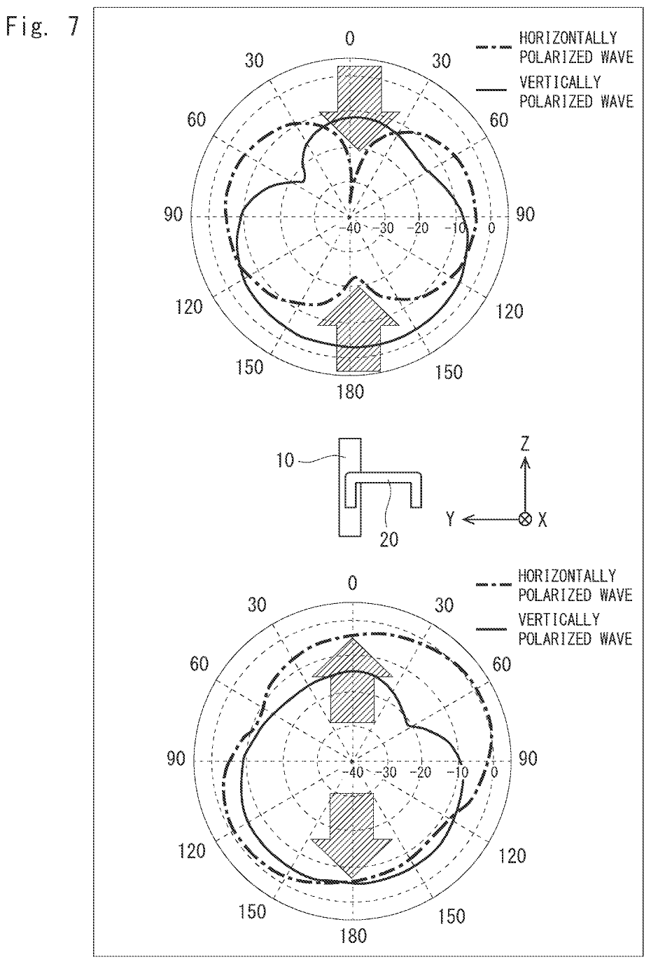

FIG. 5 is a graph illustrating antenna performances of the radio communication apparatus and the radio communication system according to the first example embodiment, and the upper part thereof shows a case in which the radio communication apparatus is a single unit and the lower part thereof shows a case in which the antenna is added to the radio communication apparatus. FIG. 6 is a graph illustrating antenna performances of the radio communication apparatus and the radio communication system according to the first example embodiment, and the upper part thereof shows a case in which the radio communication apparatus is a single unit and the lower part thereof shows a case in which the antenna is added to the radio communication apparatus. FIG. 7 is a graph illustrating antenna performances of the radio communication apparatus and the radio communication system according to the first example embodiment, and the upper part thereof shows a case in which the radio communication apparatus is a single unit and the lower part thereof shows a case in which the antenna is added to the radio communication apparatus. The radio communication apparatus 10 is, for example, a single mobile WiFi router, and the antenna 20 is mounted on the installation part 29 such as a charging cradle.

As shown in the upper part of FIG. 5, in the case in which the radio communication apparatus 10 is a single unit, both horizontally polarized waves and vertically polarized waves spread in all directions in an XZ plane centered on the front direction (the Y-axis direction). However, the intensity of the vertically polarized wave is smaller than that of the horizontally polarized wave. As shown in the lower part of FIG. 5, even in the case in which the antenna 20 is added, both the horizontally polarized waves and the vertically polarized waves spread in all directions in the XZ plane centered on the front direction (the Y-axis direction). However, as compared with the case in which the radio communication apparatus 10 is a single unit, the intensity of the vertically polarized wave increases in all directions, and is equal to the intensity of the horizontally polarized wave.

As shown in the upper part of FIG. 6, in the case in which the radio communication apparatus 10 is a single unit, the vertically polarized waves spread in all directions in an XY plane centered on the upper surface direction (the Z-axis direction). However, regarding the horizontally polarized wave, the intensity thereof in the side surface direction (the X-axis direction) when viewed from the upper surface direction is reduced and recessed. As shown in the lower part of FIG. 6, in the case in which the antenna 20 is added, both the horizontally polarized waves and the vertically polarized waves spread in all directions in the XY plane centered on the upper surface direction (the Z-axis direction). As described above, a charging cradle on which the antenna 20 is mounted is designed so that radio waves can be radiated in all directions in order to eliminate radio waves being radiated in weak directions.

As shown in the upper part of FIG. 7, in the case in which the radio communication apparatus 10 is a single unit, the vertically polarized waves spread in all directions in an YZ plane centered on the side surface direction (the X-axis direction). However, regarding the horizontally polarized wave, the intensity thereof in the upper and lower surface directions (the Z-axis direction) when viewed from the side surface direction is reduced and recessed. As shown in the lower part of FIG. 7, in the case in which the antenna 20 is added, both the horizontally polarized waves and the vertically polarized waves spread in all directions in the YZ plane centered on the side surface direction (the X-axis direction).

Next, effects of this example embodiment will be described.

In the antenna 20 according to the first example embodiment, the parasitic antenna element 21 is formed using a transparent conduction film. Therefore, the design quality of the antenna can be improved since the outward appearance thereof is simple.

Further, since the parasitic antenna element 21 is a non-contact antenna element, it is not necessary for it to be connected to the feeding point 13. Therefore, processing for adding, in order to connect the parasitic antenna element 21 to the feeding point 13, a reinforcing plate and a conductive adhesive to a soft and brittle transparent conduction film can be eliminated, and thus it is possible to manufacture the antenna at a low cost.

The radio communication system 1 according to the first example embodiment includes the antenna 20 including the parasitic antenna element 21 in the radio communication apparatus 10 that functions independently as a radio communicator. This configuration can improve the antenna performance of the radio communication apparatus 10. That is, the efficiency and bandwidth of an antenna, the multi-polarization, and the directivity in all directions can be improved.

### Second Example Embodiment

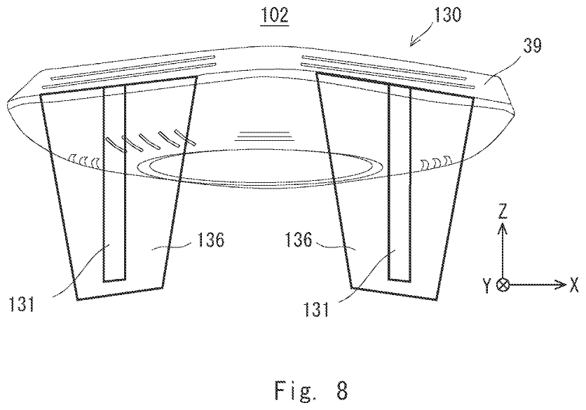

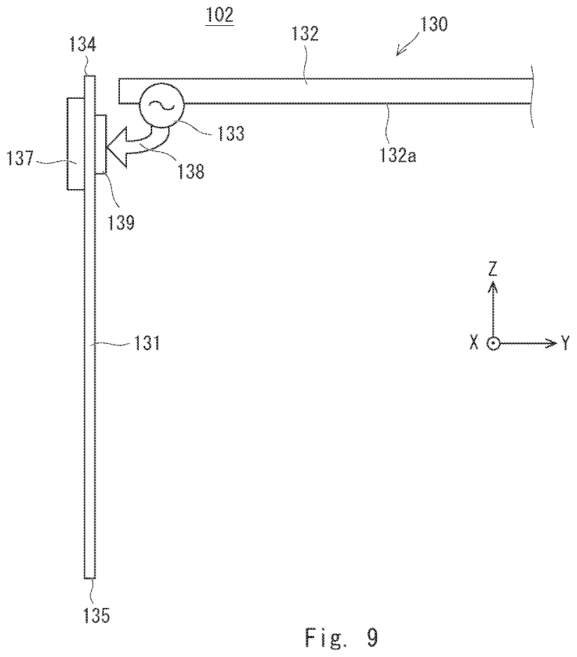

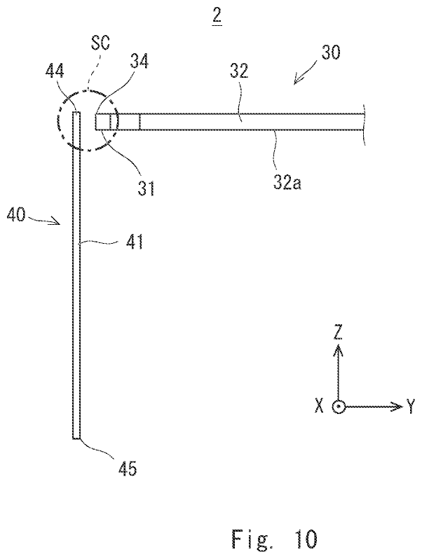

Next, an antenna and a radio communication system according to a second example embodiment will be described. A parasitic antenna element of the antenna according to the second example embodiment is suspended from a ceiling. A radio communication apparatus is mounted on the ceiling. In order to make an understanding of the antenna and the radio communication system according to the second example embodiment clearer, a comparison between it and a radio communication system according to a comparative example 2 will be described. FIG. 8 is a diagram illustrating the radio communication system according to the comparative example 2. FIG. 9 is a configuration diagram illustrating the radio communication system according to the comparative example 2. Each of FIGS. 10 and 11 is a configuration diagram illustrating the antenna and the radio communication system according to the second example embodiment.

As shown in FIGS. 8 and 9, a radio communication system 102 according to the comparative example 2 includes a radio communication apparatus 130. The radio communication apparatus 130 functions as a radio communicator. The radio communication apparatus 130 is, for example, a ceiling-mounted radio router. Note that the radio communication apparatus 130 is not limited to a ceiling-mounted radio router. The radio communication apparatus 130 includes a feeding antenna element 131, a substrate 132, and a feeding point 133. The feeding point 133 of the substrate 132 includes a connector 138 attached to the feeding point 133 for connecting it to the feeding antenna element 131. The substrate 132 and the feeding point 133 are disposed inside a disk-shaped housing 39. The housing 39 is attached to the ceiling of a building. The feeding antenna element 131 is suspended from an end part of the housing 39 attached to the ceiling.

The substrate 132 is, for example, a printed circuit board on which components of the radio communication apparatus 130 are mounted. The substrate 132 includes, for example, a rectangular substrate surface 132a.

Here, an XYZ-orthogonal coordinate system is introduced for the sake of describing the radio communication system 102. A direction perpendicular to the substrate surface 132a of the substrate 132 is defined as the Z-axis direction. For example, a direction downward from the ceiling is defined as the −Z-axis direction. Two orthogonal directions parallel to the substrate surface 12a are defined as the X-axis direction and the Y-axis direction. For example, each side of the substrate 132 is extended along the X-axis and the Y-axis directions.

The feeding antenna element 131 has a thin belt-like shape formed so as to extend in one direction. The feeding antenna element 131 has, for example, one end 134 and an other end 135. For example, a part of the feeding antenna element 131 from the one end 134 to the other end 135 extends in the −Z-axis direction. That is, the feeding antenna element 131 is suspended downward from the ceiling.

The feeding antenna element 131 is formed using a transparent conduction film. The transparent conduction film has conductivity. Further, the transparent conduction film is transparent, and thus one side of the transparent conduction film can be seen from the other side therethrough. Since the transparent conduction film is thin, the feeding antenna element 131 may be fixed to, for example, an acrylic antenna element stay 136.

The one end 134 side of the feeding antenna element 131 is fixed to a reinforcing plate 137. The connector 138 is connected to a surface of the feeding antenna element 131 opposite to the surface thereof to which the reinforcing plate 137 is fixed by using a conductive adhesive 139 such as a silver paste. In this way, the feeding antenna element 131 is connected to the feeding point 133 of the substrate 132 via the connector 138.

In the radio communication system 102 according to the comparative example, in order for the radio communication apparatus 130 to function as a radio communicator, a driving current is sent through the feeding antenna element 131 so that it radiates radio waves. Further, the feeding antenna element 131 is formed using a transparent conduction film.

In the above-described radio communication system 102, the feeding antenna element 131 formed using an aluminum film may have an intimidating effect. This is because the feeding antenna element 131 is suspended from the ceiling and thus comes within sight of a person passing under the feeding antenna element 131. On the other hand, when a transparent conduction film is used for the feeding antenna element 131, the intimidating effect of the antenna is reduced and the outward appearance thereof can be simple, and thus the design quality thereof can be improved.

However, the feeding antenna element 131 is of a contact type, and is brought into contact with the substrate 132 via the connector 138. Therefore, the radio communication system 102 physically supplies a current from the substrate 132 for generating radio waves to the feeding antenna element 131 via the connector 138. Thus, it is necessary for the feeding antenna element 131 to be processed using the reinforcing plate 137, the conductive adhesive 139, and the like. The reinforcing plate 137 is used for enhancing the connection strength, and the conductive adhesive 139 is used for securing the connectivity of the feeding antenna element 131 with the connector 138. Therefore, the manufacturing cost increases.

Next, the antenna and the radio communication system according to the second example embodiment will be described. As shown in FIGS. 10 and 11, a radio communication system 2 according to the second example embodiment includes a radio communication apparatus 30 and an antenna 40. In FIGS. 10 and 11, an XYZ-orthogonal coordinate system similar to that used in FIGS. 8 and 9 is used. The radio communication apparatus 30 functions as a radio communicator. The radio communication apparatus 30 is, for example, a ceiling-mounted radio router. Note that the radio communication apparatus 30 is not limited to a ceiling-mounted radio router. The radio communication apparatus 30 includes a feeding antenna element 31, a substrate 32, and a feeding point 33 inside the disk-shaped housing 39 shown in FIG. 8. The substrate 32 is, for example, a printed circuit board on which components of the radio communication apparatus 30 are mounted. The feeding point 33 is disposed in the substrate 32. For example, the feeding antenna element 31 is connected to the substrate 32 via the feeding point 33. The substrate 32 includes, for example, a rectangular substrate surface 32a.

The feeding antenna element 31 has, for example, an inverted L-shape in which a thin metal piece having one end 34 and an other end 35 is bent at a right angle in a bending part 36. A part of the feeding antenna element 31 from the one end 34 to the bending part 36 extends in the −X-axis direction. A part of the feeding antenna element 31 from the bending part 36 to the other end 35 extends in the +Y-axis direction. For example, the length of the feeding antenna element 31 from the one end 34 to the bending part 36 is longer than the length thereof from the other end 35 to the bending part 36. Note that the shape of the feeding antenna element 31 is not limited to an L-shape, and may instead be, for example, an inverted L-shape or an F-shape. Further, the feeding antenna element 31 may be formed on the substrate 32 or it may be formed on a chip or the like, and it may be a single element.

The other end 35 of the feeding antenna element 31 is connected to the feeding point 33 of the substrate 32. A driving current is supplied from the feeding point 33 to the feeding antenna element 31. By the above, the feeding antenna element 31 radiates radio waves. The feeding antenna element 31 is disposed, for example, in an end part of the housing 39.

The antenna 40 includes a parasitic antenna element 41. The parasitic antenna element 41 is formed using a transparent conduction film. The transparent conduction film has conductivity. Further, the transparent conduction film is transparent, and thus one side of the transparent conduction film can be seen from the other side therethrough. The parasitic antenna element 41 enhances an antenna performance of the feeding antenna element 31 in the radio communication apparatus 30.

The parasitic antenna element 41 has a thin belt-like shape formed so as to extend in one direction. The parasitic antenna element 41 has, for example, one end 44 and an other end 45. For example, a part of the parasitic antenna element 41 from the one end 44 to the other end 45 extends in the −Z-axis direction. That is, the parasitic antenna element 41 is suspended downward from the ceiling. Therefore, the appearance of the radio communication system according to this example embodiment is the same as that according to the comparative example except that the feeding antenna element 131 shown in FIG. 8 is replaced with the parasitic antenna element 41. However, the parasitic antenna element 41 is not in contact with the feeding point 33 of the substrate 32, and is also not in contact with other feeding points. Since the transparent conduction film is thin, the parasitic antenna element 41 may be fixed to, for example, the acrylic antenna element stay 136.

The parasitic antenna element 41 is spatially coupled to the feeding antenna element 31. For example, the parasitic antenna element 41 is located near the feeding antenna element 31 of the radio communication apparatus 30. Further, a length of the parasitic antenna element 41 from the one end 44 to the other end 45 is approximately ½ of a wavelength of a radio wave radiated by the feeding antenna element 31. Therefore, the one end 34 of the feeding antenna element 31 and the one end 44 of the parasitic antenna element 41 are spatially coupled to each other at the space coupling part SC. By the above, an induction current is generated in the parasitic antenna element 41 by the driving current of the feeding antenna element 31. The induction current generated in the parasitic antenna element 41 may have a current component in which a direction thereof is different from the direction of the driving current. The induction current generated in the parasitic antenna element 41 is a resonance current.

Since the parasitic antenna element 41 and the feeding antenna element 31 are spatially coupled to each other, the need for the parasitic antenna element 41 to be processed using the reinforcing plate 137, the conductive adhesive 139, and the like and to include the connector 138 can be eliminated. Therefore, it is possible to improve the design quality of the antenna at a low cost. However, as compared with the radio communication system 102 according to the comparative example 2, it is necessary to provide the feeding antenna element 31 in the substrate 32 of the radio communication apparatus 30. The configurations and the effects other than the above ones are the same as those described with reference to the first example embodiment.

### Third Example Embodiment

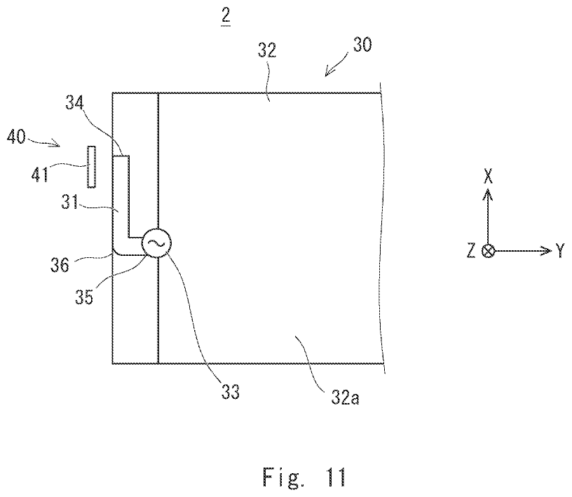

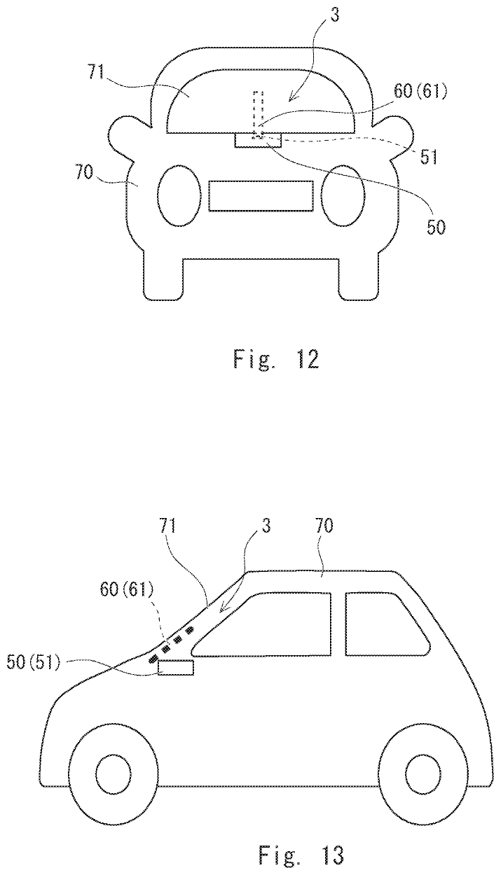

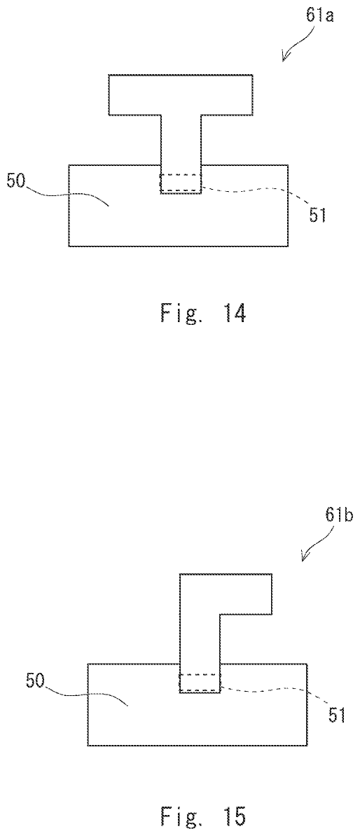

Next, an antenna and a radio communication system according to a third example embodiment will be described. In the antenna according to the third example embodiment, a parasitic antenna element is disposed, for example, in a window of a conveyance, and a radio communication apparatus is disposed inside the conveyance. Each of FIGS. 12 and 13 is a diagram illustrating the antenna and the radio communication system according to the third example embodiment. In FIG. 12, a vehicle 70 exemplified as a conveyance is shown in a state in which it faces forward, and in FIG. 13, the vehicle 70 exemplified as a conveyance is shown in a state in which it faces the horizontal direction. Each of FIGS. 14 and 15 is a diagram illustrating another shape of the antenna according to the third example embodiment. As shown in FIGS. 12 and 13, a radio communication system 3 includes a radio communication apparatus 50 and an antenna 60.

The radio communication apparatus 50 is, for example, a vehicle-mounted radio communicator referred to as a data communication module (DCM). The DCM can make an emergency call and send information about a vehicle to a mobile phone network in the event of an accident. Note that the radio communication apparatus 50 is not limited to the DCM. The radio communication apparatus 50 is, for example, mounted on a dashboard. The radio communication apparatus 50 includes a feeding antenna element 51 therein. The functions of the feeding antenna element 51 of the radio communication apparatus 50 are similar to those of the feeding antenna elements 11 and 31 described above.

The antenna 60 includes a parasitic antenna element 61 formed using a transparent conduction film. The antenna 60 is attached onto a window 71, for example, a windshield, of the vehicle 70. The parasitic antenna element 61 of the antenna 60 is spatially coupled to the feeding antenna element 51 of the radio communication apparatus 50. By the above, the antenna 60 increases the number of radio waves emitted outside the vehicle by the radio communication apparatus 50.

When the transmittance of a transparent conduction film is equal to or higher than the specified transmittance, it does not violate the safety standards established by the Ministry of Land, Infrastructure, Transport and Tourism. Therefore, it is possible to attach the antenna onto a window without resulting in danger to a driver. Note that when there is a risk of the field of view of a driver being obstructed, the antenna element may be changed to a T-shaped non-contact parasitic antenna element 61a as shown in FIG. 14, or may be changed to an L-shaped non-contact parasitic antenna element 61b as shown in FIG. 15.

In a case in which a transparent conduction film is used as the feeding antenna element 131 like in the case of the radio communication system 102 according to the comparative example 2, when a window glass is broken due to the vehicle 70 being in an accident or the like, the radio communication apparatus stops the function of the radio communicator.

On the other hand, in the radio communication system 3 according to the third example embodiment, even when a window glass is broken due to the vehicle 70 being in an accident or the like and hence the antenna 60 is broken, since the radio communication apparatus 50 includes the feeding antenna element 51 therein, the radio communication apparatus 50 does not stop functioning as a radio communicator even though the antenna performance is slightly reduced.

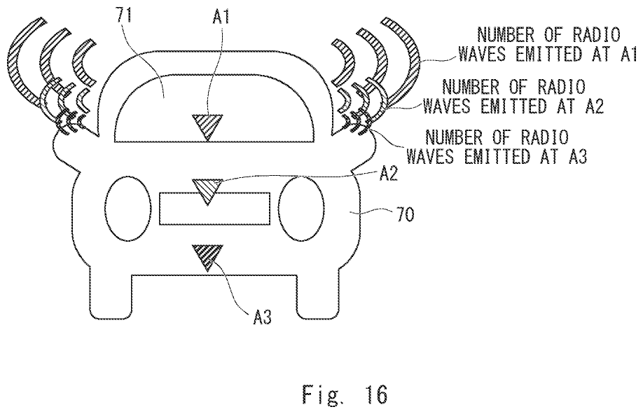

FIG. 16 is a diagram illustrating the number of radio waves emitted outside the vehicle by the radio communication system according to the third example embodiment. As shown in FIG. 16, when the position of the antenna 60 is gradually moved below the vehicle 70 so that it is at an antenna position A1, then at an antenna position A2, and then an antenna position A3, the number of radio waves emitted outside the vehicle becomes A1>A2>A3. This is because a vehicle body of the vehicle 70 is made of metal and blocks radio waves. The radio waves pass mainly through the window 71. Therefore, it is difficult for the radio waves of the antenna 60 mounted below the vehicle 70 to be radiated outside the vehicle.

The antenna 60 according to this example embodiment is attached onto the window 71 and thus it is possible to increase the number of radio waves emitted outside the vehicle. Further, the antenna 60 is formed using a transparent conduction film and thus it is possible to reduce obstruction of the field of view of a driver.

An antenna mounted on a roof of the vehicle 70 referred to as a shark fin antenna or a rod antenna is likely to fall off in the event of a rollover. Therefore, the radio communication apparatus 50 is preferably mounted inside the vehicle 70. However, this causes a disadvantage that hardly any of the radio waves emitted from the radio communication apparatus 50 mounted inside the vehicle 70 are emitted outside the vehicle.

In the radio communication system 3 according to this example embodiment, the antenna 60 is attached onto the window 71 and thus it is possible to increase the number of radio waves emitted outside the vehicle. Thus, the risk of falling out and breakage of the antenna in the event of a rollover can be reduced while the number of radio waves emitted can be increased. The configurations and the effects other than the above ones are same as those described with reference to the first and the second example embodiments.

### Fourth Example Embodiment

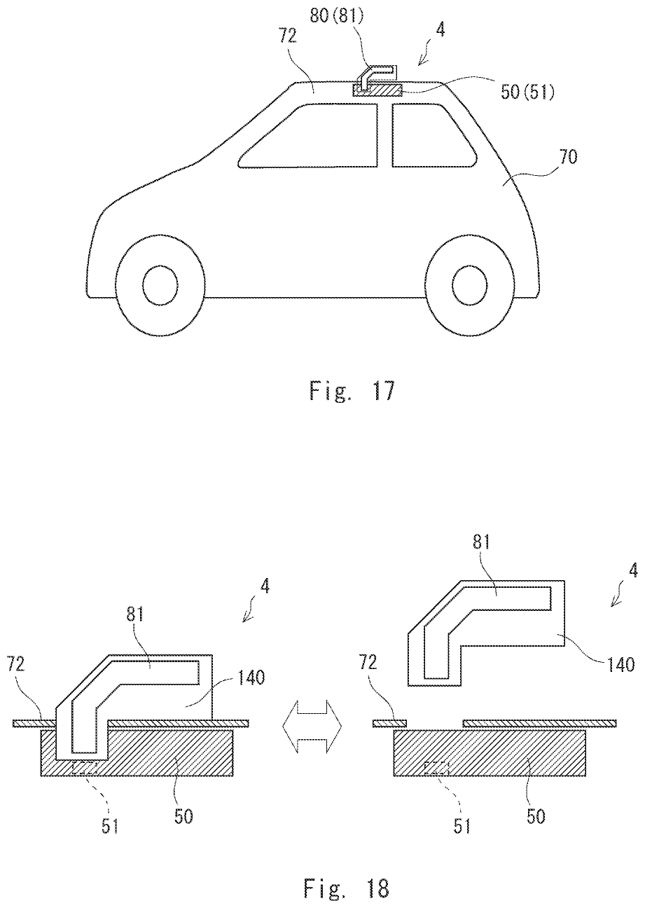

Next, an antenna and a radio communication system according to a fourth example embodiment will be described. In the antenna according to the fourth example embodiment, a parasitic antenna element is disposed, for example, on a roof of a conveyance, and a radio communication apparatus is disposed inside the conveyance so that it is located on the inner side of the roof. FIG. 17 is a diagram illustrating the antenna and the radio communication system according to the fourth example embodiment. In FIG. 17, the vehicle 70 exemplified as a conveyance is shown in a state in which it faces the horizontal direction. FIG. 18 is a diagram illustrating a state in which the antenna according to the fourth example embodiment is attached to and detached from a roof of the vehicle. As shown in FIGS. 17 and 18, a radio communication system 4 includes the radio communication apparatus 50 and an antenna 80.

The radio communication apparatus 50 is, for example, a DCM like in the third example embodiment. In this example embodiment, instead of the radio communication apparatus 50 being disposed on a dashboard, it is disposed inside the vehicle 70 so that it is located on the inner side of a roof 72 of the vehicle 70. The radio communication apparatus 50 includes the feeding antenna element 51 therein. The functions of the feeding antenna element 51 of the radio communication apparatus 50 are similar to those of the feeding antenna elements 11 and 31 described above.

The antenna 80 includes a parasitic antenna element 81 formed using a transparent conduction film. The parasitic antenna element 81 may be reinforced by bonding it to a transparent acrylic plate 140. The antenna 80 projects upward from the roof 72 of the vehicle 70. For example, the parasitic antenna element 81 is disposed on the roof 72. Specifically, the parasitic antenna element 81 is disposed, except for one end thereof, on the roof 72, and the one end of the parasitic antenna element 81 is disposed near the feeding antenna element 51 via a through hole formed in the roof 72. The parasitic antenna element 81 of the antenna 80 is spatially coupled to the feeding antenna element 51 of the radio communication apparatus 50. By the above, the antenna 80 increases the number of radio waves emitted outside the vehicle by the radio communication apparatus 50.

An antenna mounted on a roof top on the roof 72 is referred to as a shark fin, a dolphin, or the like. From a vehicle designer's point of view, the aforementioned antenna mounted on a roof top would impair the body line of the vehicle.

In this example embodiment, the radio communication apparatus 50 such as a DCM is mounted in the inner side of the roof 72, and the non-contact parasitic antenna element 81 is mounted on the roof top. By doing the above, it is possible to improve the design quality of the antenna by giving it a simple outward appearance. Further, since the antenna element is transparent, toning can be eliminated. Further, since it can be easily replaced with another antenna by inserting it into the through hole of the roof 72, the cost can be reduced.

In the radio communication system 4 according to the fourth example embodiment, even when the antenna 80 is broken, since the radio communication apparatus 50 includes the feeding antenna element 51 therein, the radio communication apparatus 50 does not stop functioning as a radio communicator even though the antenna performance is slightly reduced.

Note that the present invention is not limited to the above-described example embodiments and may be changed as appropriate without departing from the spirit of the present invention. For example, the combination of the configurations of the first to the fourth example embodiments is within the scope of the technical idea of the present invention. The whole or part of the example embodiments disclosed above can be described as, but not limited to, the following supplementary notes.

### Supplementary Note 1

A radio communication system comprising:
a radio communication apparatus comprising a feeding antenna element, the radio communication apparatus being configured to function as a radio communicator; and
an antenna comprising a parasitic antenna element formed using a transparent conduction film, wherein
the parasitic antenna element is not in contact with a feeding point and is disposed near the feeding antenna element, and
an induction current is generated in the parasitic antenna element by a driving current of the feeding antenna element.

### Supplementary Note 2

The radio communication system according to Supplementary note 1, wherein the induction current is a resonance current.

### Supplementary Note 3

The radio communication system according to Supplementary note 1 or 2, wherein the parasitic antenna element is disposed in a charger of the radio communication apparatus.

### Supplementary Note 4

The radio communication system according to Supplementary note 1 or 2, wherein
the radio communication apparatus is mounted on a ceiling, and
the parasitic antenna element is suspended from the ceiling.

### Supplementary Note 5

The radio communication system according to Supplementary note 1 or 2, wherein
the radio communication apparatus is disposed inside a conveyance, and
the parasitic antenna element is disposed in a window of the conveyance.

### Supplementary Note 6

The radio communication system according to any one of Supplementary notes 1 to 5, wherein the parasitic antenna element has a bent shape.

### Supplementary Note 7

The radio communication system according to any one of Supplementary notes 1 to 6, wherein the feeding antenna element has an inverted L-shape.

### Supplementary Note 8

The radio communication system according to any one of Supplementary notes 1 to 7, wherein the parasitic antenna element has one end and an other end, and a length thereof from the one end to the other end is approximately ½ of a wavelength of a radio wave emitted by the feeding antenna element.

### Supplementary Note 9

The radio communication system according to any one of Supplementary notes 1 to 8, wherein
the feeding antenna element has one end and an other end that is connected to a feeding point,
the parasitic antenna element has one end and an other end, and
the one end of the feeding antenna element is spatially coupled to the one end of the parasitic antenna element.

Although the present invention has been described with reference to the example embodiments, the present invention is not limited to the above-described example embodiments. Various changes that may be understood by those skilled in the art may be made to the configurations and details of the present invention within the scope of the invention.

This application is based upon and claims the benefit of priority from Japanese patent application No. 2019-195862, filed on Oct. 29, 2019, the disclosure of which is incorporated herein in its entirety by reference.

### REFERENCE SIGNS LIST

1, 2, 3, 4, 101, 102 RADIO COMMUNICATION SYSTEM
10, 30, 50, 130 RADIO COMMUNICATION APPARATUS
11, 31, 51, 131 FEEDING ANTENNA ELEMENT
12, 32, 132 SUBSTRATE
12a SUBSTRATE SURFACE
13, 33, 133 FEEDING POINT
14, 34, 134 ONE END
15, 35, 135 OTHER END
16, 36 BENDING PART
19, 39 HOUSING
20, 40, 60, 80, 120 ANTENNA
21, 41, 61, 61a, 61b, 81, 121 PARASITIC ANTENNA ELEMENT
24, 44, 124 ONE END
25, 45, 125 OTHER END
26, 27, 126, 127 BENDING PART
28 RECESSED PART
29 INSTALLATION PART
29a BASE
29b SUPPORT PART
70 VEHICLE
71 WINDOW
72 ROOF
136 ANTENNA ELEMENT STAY
137 REINFORCING PLATE
138 CONNECTOR
139 CONDUCTIVE ADHESIVE
140 ACRYLIC PLATE

1. An antenna comprising a parasitic antenna element formed using a transparent conduction film, wherein
the parasitic antenna element is not in contact with a feeding point and is disposed near a feeding antenna element of a radio communication apparatus configured to function as a radio communicator, and
an induction current is generated in the parasitic antenna element by a driving current of the feeding antenna element.

2. The antenna according to claim 1, wherein the induction current is a resonance current.

3. The antenna according to claim 1 or 2, wherein the parasitic antenna element is disposed in a charger of the radio communication apparatus.

4. The antenna according to claim 1 or 2, wherein
the radio communication apparatus is mounted on a ceiling, and
the parasitic antenna element is suspended from the ceiling.

5. The antenna according to claim 1 or 2, wherein
the radio communication apparatus is disposed inside a conveyance, and
the parasitic antenna element is disposed in a window of the conveyance.

6. The antenna according to any one of claims 1 to 5, wherein the parasitic antenna element has a bent shape.

7. The antenna according to any one of claims 1 to 6, wherein the feeding antenna element has an inverted L-shape.

8. The antenna according to any one of claims 1 to 7, wherein the parasitic antenna element has one end and an other end, and a length thereof from the one end to the other end is approximately ½ of a wavelength of a radio wave emitted by the feeding antenna element.

9. The antenna according to any one of claims 1 to 8, wherein
the feeding antenna element has one end and an other end that is connected to a feeding point,
the parasitic antenna element has one end and an other end, and
the one end of the feeding antenna element is spatially coupled to the one end of the parasitic antenna element.

10. A radio communication system comprising:
a radio communication apparatus comprising a feeding antenna element, the radio communication apparatus being configured to function as a radio communicator; and
an antenna comprising a parasitic antenna element formed using a transparent conduction film, wherein
the parasitic antenna element is not in contact with a feeding point and is disposed near the feeding antenna element, and
an induction current is generated in the parasitic antenna element by a driving current of the feeding antenna element.

11. The radio communication system according to claim 10, wherein the induction current is a resonance current.

12. The radio communication system according to claim 10 or 11, wherein the parasitic antenna element is disposed in a charger of the radio communication apparatus.

13. The radio communication system according to claim 10 or 11, wherein
the radio communication apparatus is mounted on a ceiling, and
the parasitic antenna element is suspended from the ceiling.

14. The radio communication system according to claim 10 or 11, wherein
the radio communication apparatus is disposed inside a conveyance, and
the parasitic antenna element is disposed in a window of the conveyance.

15. The radio communication system according to any one of claims 10 to 14, wherein the parasitic antenna element has a bent shape.

16. The radio communication system according to any one of claims 10 to 15, wherein the feeding antenna element has an inverted L-shape.

17. The radio communication system according to any one of claims 10 to 16, wherein the parasitic antenna element has one end and an other end, and a length thereof from the one end to the other end is approximately ½ of a wavelength of a radio wave emitted by the feeding antenna element.

18. The radio communication system according to any one of claims 10 to 17, wherein
the feeding antenna element has one end and an other end that is connected to a feeding point,
the parasitic antenna element has one end and an other end, and
the one end of the feeding antenna element is spatially coupled to the one end of the parasitic antenna element.
